(19) United States
(12) Patent Application Publication
(10) Pub. No.: US 2008/0186324 A1
(43) Pub. Date: Aug. 7, 2008

(54) Method for generating a frame stream to be displayed on a display device

(76) Inventor: Ching-Yueh Chiang, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/025,763

(22) Filed: Feb. 5, 2008

(30) Foreign Application Priority Data
Feb. 5, 2007 (TW) 096104155

(51) Int. Cl. G09G 5/02

(52) U.S. Cl. 345/589

(57) ABSTRACT

A method of dark frame insertion for improving a display device is disclosed. The method includes receiving a gray level data stream, generating a first brightness data stream according to a first gamma curve, generating a second brightness data stream according to a second gamma curve, sequentially inserting the second brightness data stream into the first brightness data stream for generating a third brightness data stream, and providing the third brightness data stream to the display device for display.

### BACKGROUND OF THE INVENTION

1. Field of the Invention

The present invention relates to a method for generating a frame stream to be displayed on a display device, and more particularly, a method for generating a frame stream to be displayed on a liquid crystal display (LCD) device.

2. Description of the Prior Art

Please refer to FIG. 1. FIG. 1 is a diagram illustrating displaying difference between a Cathode Ray Tube (CRT) display device and a Liquid Crystal Display (LCD) device. FIG. 1A is a diagram illustrating the brightness of a pixel of the CRT display device; FIG. 1B is a diagram illustrating the brightness of a pixel of the LCD device. It is assumed that: during frame 1 period, the gray level of the pixel of the CRT display device is 30 and the corresponding brightness is 3, during frame 2 period, the gray level of the pixel of the CRT display device is 20 and the corresponding brightness is 2, and during frame 3 period, the gray level of the pixel of the CRT display device is 10 and the corresponding brightness is 1. In this way, the brightness of the pixel of the CRT display device varies as shown in FIG. 1A: during frame 1 period, the brightness of the pixel of the CRT display device is 3 when the CRT display device is scanning the pixel, and then becomes 0; during frame 2 period, the brightness of the pixel of the CRT display device is 2 when the CRT display device is scanning the pixel, and then becomes 0; during frame 3 period, the brightness of the pixel of the CRT display device is 1 when the CRT display device is scanning the pixel, and then becomes 0. Similarly, it is assumed that: during frame 1 period, the gray level of the pixel of the LCD device is 30 and the corresponding brightness is 3, during frame 2 period, the gray level of the pixel of the LCD device is 20 and the corresponding brightness is 2, and during frame 3 period, the gray level of the pixel of the LCD device is 10 and the corresponding brightness is 1. In this way, the brightness of the pixel of the LCD device varies as shown in FIG. 1B: during frame 1 period, the brightness of the pixel of the LCD device keeps at 3 until the next frame; during frame 2 period, the brightness of the pixel of the LCD device keeps at 2 until the next frame; and during frame 3 period, the brightness of the pixel of the LCD device keeps at 1 until the next frame.

Please continue referring to FIG. 1. In FIG. 1B, the brightness of the pixel varies between the frame 1 period and the frame 2 period, and between the frame 2 period and the frame 3 period. The liquid crystal of the LCD device is driven to rotate by the voltage applied on the liquid crystal and the rotation caused by the voltage is of continuity. That is, when the liquid crystal rotates to a first angle so as to enable the brightness of the pixel to be 2, if the liquid crystal is further driven to rotate to a second angle to enable the brightness of the pixel to be 1, the liquid crystal gradually rotates from the first angle to the second angle. Consequently, the brightness of the pixel varies from 2 gradually to 1 instead of jumping from 2 to 1, which forms the brightness curve as shown in FIG. 1C. In FIG. 1C, a response time P exists between the gap of the brightness from 2 to 1 and from 3 to 2. In the response time P, the accumulated brightness X is generated. When a person watches the frames of the LCD device, the brightness of the frames is retained in the person's eyes for a short time. Further, the brightness at the end of each of the frames (accumulated brightness X) enhances such situation, which causes the tiredness of the person's eyes and thus the “ghost shadow” effect is generated.

Please refer to FIG. 2. FIG. 2 is a diagram illustrating a conventional method of dark frame insertion for eliminating the ghost shadow effect of the LCD device. FIG. 2A is same as FIG. 1A. FIG. 2B is similar to FIG. 1B: in the frame 1, the brightness is 3; in the frame 2 period, the brightness is 2; in the frame 3 period, the brightness is 1. The difference between FIG. 2B and FIG. 1B is: in FIG. 2B, the duration of the brightness for a frame is reduced by a half. That is, if a duration of a frame is T, thus in the first half period of the duration T, the brightness of the frame remains the original brightness, and in the second half period of the duration T, the brightness of the frame reduces to 0 (complete dark status). For example, in the first half period of the duration T of the frame period 1, the brightness of the pixel is 3, and in the second half period of the duration T of the frame period 1, the brightness of the pixel is 0; in the first half period of the duration T of the frame period 2, the brightness of the pixel is 2, and in the second half period of the duration T of the frame 2 period, the brightness of the pixel is 0; and in the first half period of the duration T of the frame 3 period, the brightness of the pixel is 1, and in the second half period of the duration T of the frame 3 period, the brightness of the pixel is 0. In fact, the original frames are inserted with complete dark frames as shown in FIG. 2B. Therefore, the frequency of the LCD device transmitting data to the pixels is doubled because of the double data quantity (original frames and the inserted dark frames) while the frame rate of the LCD device keeps the same. For example, if the frame rate of the LCD device insertion is 60 Hz, the frequency of the LCD device transmitting data to the pixels (with dark frame insertion) is 120 Hz. The above method of dark frame insertion is designed to simulate the operation of the CRT display device for lowering the ghost shadow effect.

Though the method in FIG. 2B improves the ghost shadow effect, image flicking is generated. Such situation gets worse when the pixel has the same brightness in several frames. FIG. 3A is a diagram illustrating a brightness of a pixel of an LCD device without conventional dark frame insertion: during the frame 1 period, the brightness of the pixel remains 2; during the frame 2 period, the brightness of the pixel remains 2; and during the frame 3 period, the brightness of the pixel remains 2. Thus, there is not any image flicking problem when the person watches the LCD device displaying the frames of FIG. 3A. FIG. 3B is a diagram illustrating a brightness of a pixel of an LCD device with conventional dark frame insertion according to the original frames in FIG. 3A: during the frame 1 period, the brightness of the pixel remains 2 in the first half period and remains 0 in the second half period; during the frame 2 period, the brightness of the pixel remains 2 in the first half period and remains 0 in the second half period; and during the frame 3 period, the brightness of the pixel remains 2 in the first half period and remains 0 in the second half period. Thus, the person can feel the image flicking when watching the LCD device with the conventional dark frame insertion. Although the conventional dark frame insertion improves the ghost shadow effect, the image flicking problem is generated, which lowers the quality of the LCD device.

### SUMMARY OF THE INVENTION

The present invention provides a method for generating a frame stream to be displayed on a display device. The method comprises (a) receiving a gray level data stream, (b) generating a first brightness data stream according to the gray level data stream and a first gray level to brightness transformation, (c) generating a second brightness data stream according to the gray level data stream and a second gray level to brightness transformation, and (d) forming the frame stream by making the first brightness data stream interlaced with the second brightness data, wherein the first gray level to brightness transformation and the second gray level to brightness transformation make at least part of the gray level data stream correspond to non-zero brightness.

The present invention further provides a method for generating a frame stream to be displayed on a display device. The method comprises (a) receiving a gray level data stream, (b) generating a first brightness data stream according to the gray level data stream and a first gray level to brightness transformation, (c) generating a second brightness data stream according to the gray level data stream and a second gray level to brightness transformation, (d) forming a interlaced stream by making the first brightness data stream interlaced with the second brightness data, and (e) forming the frame stream by removing a system data from the interlaced stream, wherein the first gray level to brightness transformation and the second gray level to brightness transformation make at least part of the gray level data stream correspond to non-zero brightness.

The present invention further provides a display device with dark frame insertion. The display device comprises a receiving device for receiving a gray level data stream, a first brightness generating device for generating a first brightness data stream according to the gray level data stream and a first gray level to brightness transformation, a second brightness generating device for generating a second brightness data stream according to the gray level data stream and a second gray level to brightness transformation, and a data interlacing device for interlacing the first brightness data stream with the second brightness data stream and providing the first brightness data stream interlaced with the second brightness data stream to the display device for displaying a frame stream, wherein both the first gray level to brightness transformation and the second gray level to brightness transformation make at least part of the gray level data stream correspond to non-zero brightness.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a display difference between a CRT display device and an LCD device.

FIG. 2 is a diagram illustrating conventional method of dark frame insertion for eliminating the ghost shadow effect of the LCD device.

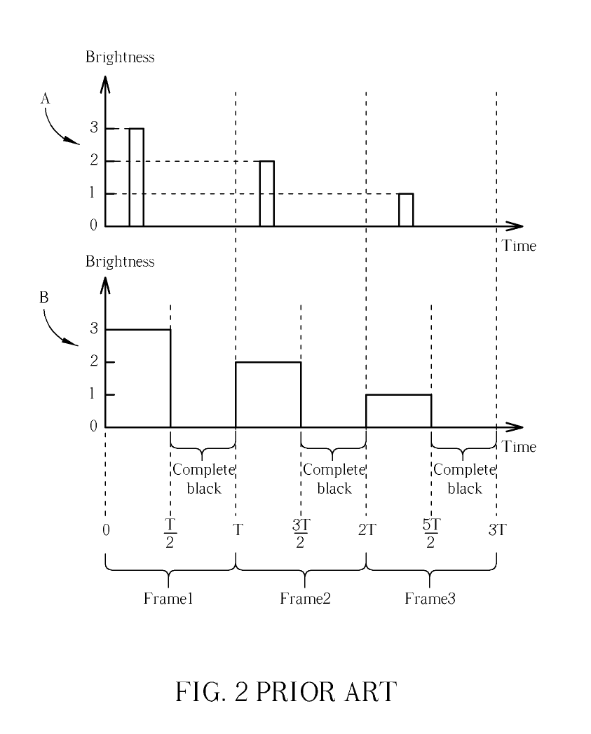

FIG. 3 is a diagram illustrating image flicking of the conventional dark frame insertion.

FIG. 4 is a diagram illustrating a first embodiment according to the method of the dark frame insertion for improving the LCD device of the present invention.

FIG. 5 is a second embodiment according to the method of dark frame insertion of the present invention.

FIG. 6 is a gamma curve applied on the first embodiment according to the method of the dark frame insertion of the present invention.

FIG. 7 is a diagram illustrating a gamma curve applied on a second embodiment according to the method of the dark frame insertion of the present invention.

FIG. 8 is a diagram illustrating a gamma curve applied on a third embodiment according to the method of dark frame insertion of the present invention.

FIG. 9 is a diagram illustrating the gamma curve utilized by the third embodiment according to the method of the dark frame insertion of the present invention.

FIG. 10 is a diagram a fourth embodiment according to the method of the dark frame insertion of the present invention.

FIG. 11 is a diagram illustrating a fifth embodiment of the method of the dark frame insertion of the present invention.

FIG. 12 is a diagram illustrating the method of the present invention for reducing the amount of the frame data.

FIG. 13 is a flowchart illustrating the steps of the method of the dark frame insertion of the present invention.

### DETAILED DESCRIPTION

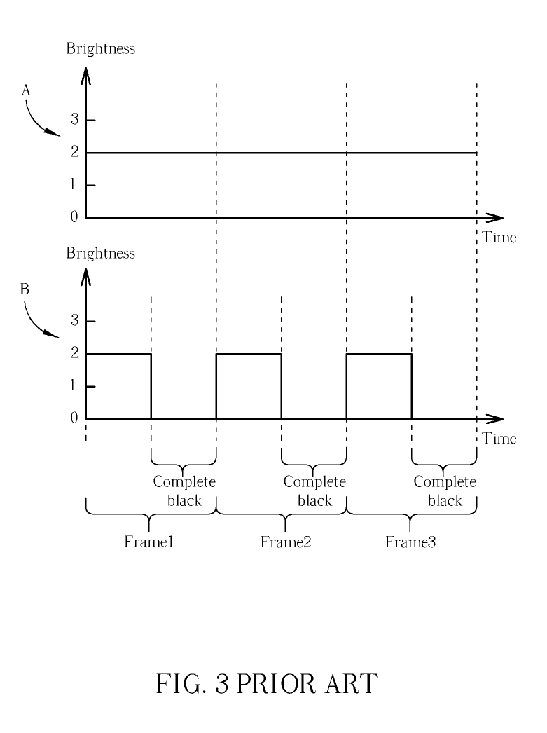

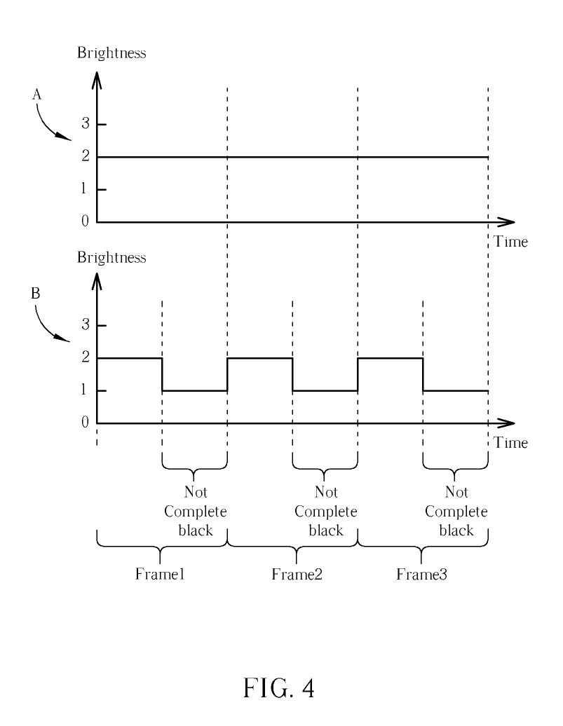

Please refer to FIG. 4. FIG. 4 is a diagram illustrating a first embodiment according to the method to generate a frame stream by inserting the dark frames into the original video frames for improving the performance of the LCD device. FIG. 4A is the same as FIG. 3A: the original brightness of one pixel is 2 from the frame 1 period to the frame 3 period.

Based on the original brightness shown in FIG. 4A, the FIG. 4B is a diagram illustrating the brightness of the same pixel after the LCD device implementing the dark frame insertion method of the present invention: in the frame 1 period, the brightness of the pixel is 2 in the first half period and 1 in the second half period; in the frame 2 period, the brightness of the pixel is 2 in the first half period and 1 in the second half period; and in the frame 3 period, the brightness of the pixel is 2 in the first half period and 1 in the second half period.

From the details described above, it shows that the dark frame insertion method of the present invention inserts a darker frame (not a complete black frame) in the second half period of each original frame period. Compared to the FIG. 3B, the brightness difference is smaller between the first half period and the second half period of each original frame period, so the image flicking problem is eased by the dark frame insertion method of the present invention.

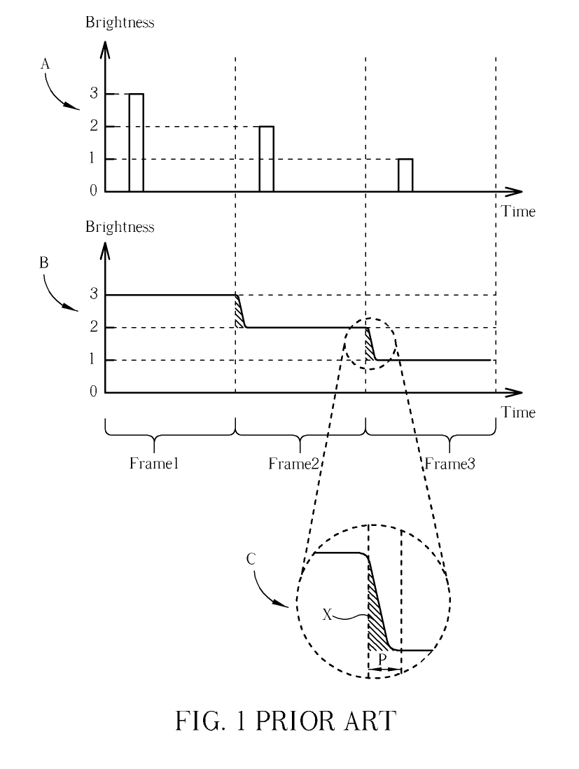

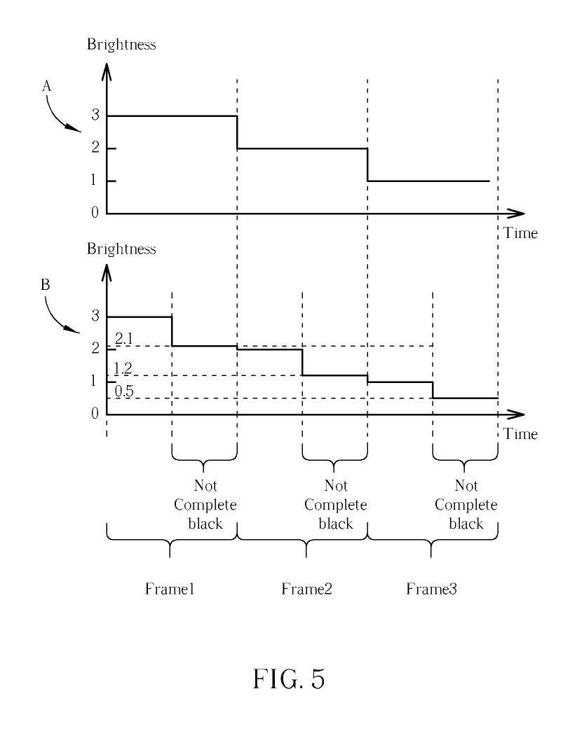

Please refer to FIG. 5. FIG. 5 is a second embodiment according to the dark frame insertion method of the present invention. FIG. 5A is same as FIG. 1B: in the frame 3 period, the brightness of the pixel remains 1; in the frame 2 period, the brightness of the pixel remains 2; in the frame 1 period, the brightness of the pixel remains 3.

Based on the original brightness shown in FIG. 5A, the FIG. 5B is a diagram illustrating the brightness of the same pixel after the LCD device implementing the dark frame insertion method of the present invention: in the frame 3 period, the brightness of the pixel is 1 in the first half period and 0.5 in the second half period; in the frame 2 period, the brightness of the pixel is 2 in the first half period and 1.2 in the second half period; and in the frame 3 period, the brightness of the pixel is 3 in the first half period and 2.1 in the second half period.

From the details described above, it shows that the dark frame insertion method of the present invention inserts a darker frame (not a complete black frame) in the second half period of each original frame period. The brightness of the inserted dark frames is proportional to the brightness of the original video frames displayed in the first half period.

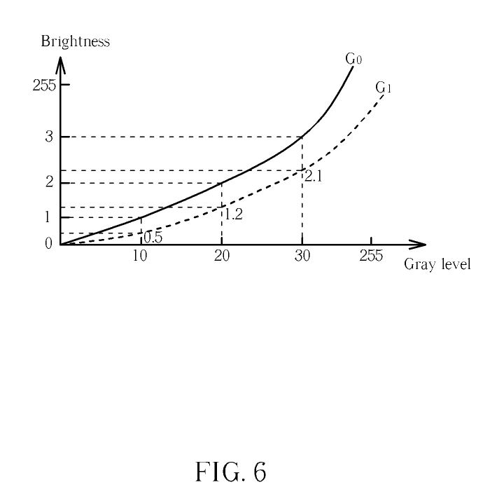

Please refer to FIG. 6 and together with FIG. 5B. FIG. 6 is a gamma curve applied on the first embodiment according to the dark frame insertion method of the present invention. FIG. 6 is a diagram illustrating the corresponding gamma curve of the original frames and the corresponding gamma curve of the inserted dark frames.

The brightness of each pixel during the first half period in each original frame period is determined based on the gamma curve G0. Based on the gamma curve G0, when the gray level value of one pixel is 10 in the frame 3 period, then the corresponding brightness value of that pixel is 1 in the first half period in the frame 3 period. Based on the gamma curve G0, when the gray level value of one pixel is 20 in the frame 2 period, then the corresponding brightness value of that pixel is 2 in the first half period in the frame 2 period. Based on the gamma curve G0, when the gray level value of one pixel is 30 in the frame 1 period, then the corresponding brightness value of that pixel is 3 in the first half period in the frame 1 period.

The brightness of each pixel during the second half period in each original frame period is determined based on the gamma curve G1. Thus, when the gray level value of one pixel is 10 in the frame 3 period, and according to the gamma curve G1, then the corresponding brightness value of that pixel is 0.5 in the second half period of the frame 3 period. When the gray level value of one pixel is 20 in the frame 2 period, and according to the gamma curve G1, then the corresponding brightness value of that pixel is 1.2 in the second half period of the frame 2 period. When the gray level value of one pixel is 30 in the frame 1 period, according to the gamma curve G1, then the corresponding brightness value of that pixel is 2.1 in the second half period of the frame 1 period.

In other words, by performing the dark frame insertion method of the present invention:

(1) during the first half period of the original frame period, the brightness of a pixel is generated based on the original gray level value of that pixel and the first gamma curve G0, and

(2) during the second half period of the original frame period, the brightness of that pixel is generated based on the original level value of that pixel and the second gamma curve G1. In this way, the brightness accumulation problem is solved and the image flicking problem is eased.

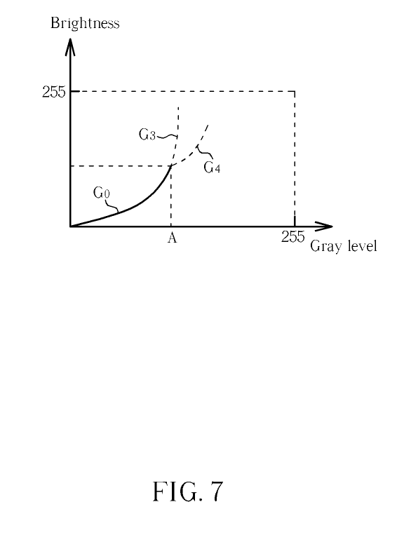

Please refer to FIG. 7. FIG. 7 is a diagram illustrating a second embodiment according to the dark frame insertion method of the present invention. As shown in FIG. 7, the horizontal axis represents the gray level and the vertical axis represents the brightness.

The gamma curve in FIG. 7 is divided into 3 sections: when the gray level is smaller than the predetermined gray level value A, the gamma curve for the first half period and the second half period of each frame is same as the original gamma curve G0. When the gray level is higher than the predetermined gray level value A, the gamma curve G3 for the first half period of each original frame period is different from the gamma curve G4 for the second half period of each original frame period, and the gamma curve G3 is mapping the same gray level to higher brightness than the gamma curve G4.

When the LCD device displays video frames, during the first half period of each frame period, the brightness is generated according to the gray level and the gamma curves G0 and G3; during the second half period of the frame, the brightness is generated according to the gray level and the gamma curves G0 and G4.

The dark frame insertion method performed based on the gamma curves shown in FIG. 7 is different from FIG. 6, because:

(1) when the gray level of the pixel is lower than the predetermined gray level value A, the brightness of the pixel in the first half period is same as the brightness of the pixel in the second half period (because of the same gamma curve G0), and

(2) when the gray level of the pixel is higher than the predetermined gray level value A, the brightness of the pixel during the first half period and the second half period is different. During the first half period, the higher pixel brightness is generated based on the gamma curve G3, and during the second half period, the lower brightness is generated based on the gamma curve G4.

In this way, when the brightness accumulation problem is not serious (for example, the gray level of the pixel is at a low value), the LCD device of the present invention does not have to modulate the brightness of the pixel into two different values, and the pixel can maintain the same brightness during the whole original frame period. When the brightness accumulating problem is serious (for example, the gray level of the pixel at a high value), the method of the present invention modulates the brightness of the pixel into two different values—higher brightness in the first half period, and lower brightness in the second half period. By reducing the brightness accumulation effect and the ghost shadow effect, the performance of the LCD device is substantially improved by the dark frame insertion method of the present invention.

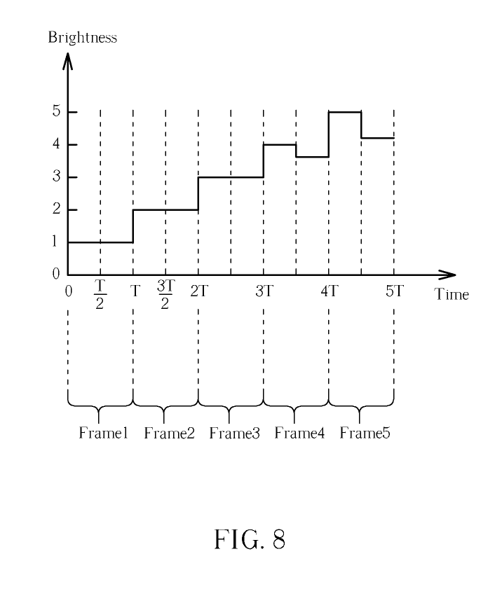

Please refer to FIG. 8. FIG. 8 is a diagram illustrating a third embodiment according to the method of dark frame insertion of the present invention. FIG. 8 is a diagram the brightness of the pixel of the LCD device utilizing the gamma curves shown in FIG. 7.

Assuming during the frame periods 1 to 3, the gray levels of one pixel are all lower than the predetermined gray level value A, so that the brightness during the first half period and the second half period both are generated based on the same gamma curve G0. Therefore, the brightness of frames 1 to 3 are same as original video frame as no dark frame is inserted.

Assuming during the frame periods 4 and 5, the gray levels of the pixel are both higher than the predetermined gray level value A, so that (1) the brightness of the pixel during the first half period is generated based on the gamma curve G3 and the original brightness of the pixel, and (2) the brightness of the pixel during the second half period (the inserted dark frame) is generated based on the gamma curve G4 and the original brightness of the pixel. Thus, in the frames 4 and 5, the brightness of the pixel in the first half period is different from the brightness of the pixel in the second half period because of the different gamma curves adopted.

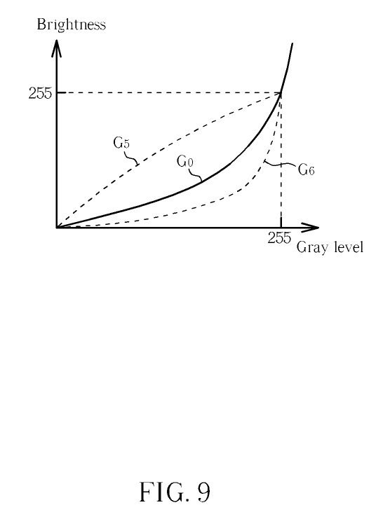

Please refer to FIG. 9. FIG. 9 is a diagram illustrating the gamma curve utilized by the third embodiment according to the dark frame insertion method of the present invention. As shown in FIG. 9, the gamma G0 is the original gamma curve, the gamma curve G5 is the gamma curve utilized in the first half period of the original frame period, and the gamma curve G6 is the gamma curve utilized in the second half period of the original frame period. The original gamma curve of the present invention can be composed of two different gamma curves. Thus, the average brightness of the pixel of the frame of the present invention (the average brightness of the brightness of the pixel in the first half period of the original frame period and the brightness of the pixel in the second half period of the original frame period) is close to the original brightness displayed on the LCD device before the dark frame is inserted.

The average brightness of the present invention is measured by the color analyzer (like: Minolta Display Color Analyzer CA-210). Thus, the frames displayed by the LCD utilizing the dark frame insertion method of the present invention have eliminated ghost shadow effects and retaining brightness.

For example, when the gray level of the pixel is 50, and the corresponding brightness according to the original gamma curve G0 is 5, i.e. the original brightness of the pixel before dark frame inserted is 5. When the targeted brightness of the pixel in the second half period is set to 2 according to the gamma curve G6. Based on these criteria, the brightness of the plurality of pixels shown on the LCD device in the first half period is adjusted (for example, gradually rises from 0) and measured by the color analyzer CA210.

When the average brightness of the plurality of pixels measured by the color analyzer CA210 is 5, it means the brightness of the entire original frame period (the first half period and the second half period) sensed by user's eyes is 5, and it is equivalent to the original video frame displayed on the LCD device based on the original gamma curve G0.

Assuming when the brightness measured by the CA210 is 5, the brightness of the pixels at the first half period is 9, so we now can define one dot of the gamma curve G5—the brightness 9 is corresponding to the gray level 50.

If the pixel gray level of the LCD device can be varied from 0 to 255, then the color analyzer will measure the LCD device screen 255 times respectively for 255 gray levels. The gamma curve G5 is inferred by measuring the plurality of pixels displayed on the LCD device with the same gray level, and the gray level for these pixels increases after the calculation for one gray level is completed.

Additionally, the sampling principle of the color analyzer CA210 is to sample the brightness of one gray level at a fixed frequency for a time period and then calculate the average brightness of the total sampled brightness for that time period. For example, if the LCD device displays the original video frames at 60 Hz, consequently after the dark frame inserted, the LCD device will display the frames at 120 Hz (the first half period as one frame and the second half period as another frame). Additionally, we set the sampling rate of the color analyzer as 60 Hz, which means each sample period will last 16.66 ms to measure the brightness of both the first half period and the second half period. Under such condition, we can also set the color analyzer CA210 to sample the plurality of pixels displayed with one gray level for 10 seconds.

Therefore, when the color analyzer CA210 samples brightness of the LCD device with the dark frame insertion method of the present invention, the color analyzer CA210 samples the brightness of the LCD device for 10 seconds with frequency of 60 Hz, which means the color analyzer CA210 samples 600 times and each sampling period is 16.66 ms. In each sampling period, the brightness of the pixels in the first half period and the brightness of the pixels in the second half period are both completely sampled. In this way, after the color analyzer CA210 continuously samples for 10 seconds, 600 sampled brightness values are obtained. The average brightness in this 10-second period is generated by averaging the 600 sampled brightness values.

Generally, the gamma curves applied on an LCD device comprises gamma 2.2 and gamma 1.8.

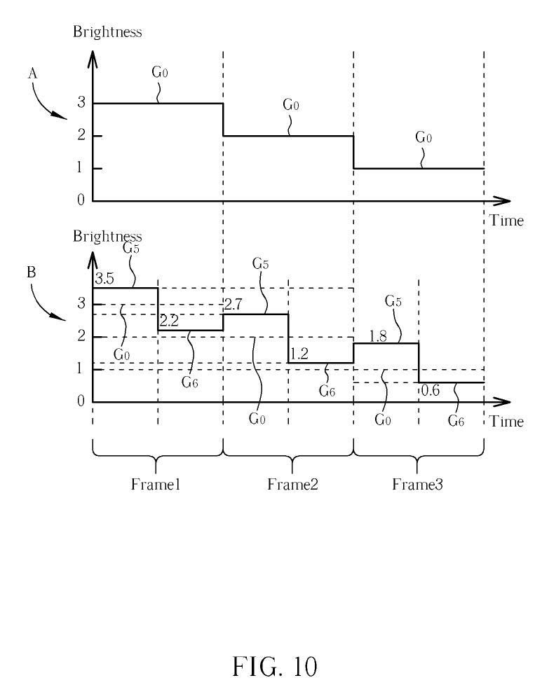

Please refer to FIG. 10. FIG. 10 is a diagram a fourth embodiment according to the dark frame insertion method of the present invention. FIG. 10 is diagram illustrating the brightness of one pixel of the LCD device utilizing the gamma curve in FIG. 9. FIG. 10A is same as FIG. 1B. The brightness of the FIG. 10B is generated by the dark frame insertion method of the present invention according to the gray levels in FIG. 10A and the gamma curve in FIG. 9: in the original frame 3 period, the gray level of the pixel is 10 and consequently the brightness of the pixel in the first half period according to the gamma curve G5 is 1.8 and the brightness of the pixel in the second half period according to the gamma curve G6 is 0.6; in the original frame 2 period, the gray level of the pixel is 20 and consequently the brightness of the pixel in the first half period according to the gamma curve G5 is 2.7 and the brightness of the pixel in the second half period according to the gamma curve G6 is 1.2; and in the original frame 1 period, the gray level of the pixel is 30 and consequently the brightness of the pixel in the first half period according to the gamma curve G5 is 3.5 and the brightness of the pixel in the second half period according to the gamma curve G6 is 2.2. Therefore, the dark frame insertion method of the present invention also can utilize two different gamma curves to eliminate ghost shadow effects while the brightness of the video frames after the dark frame inserted is still same as the brightness of the original video frames.

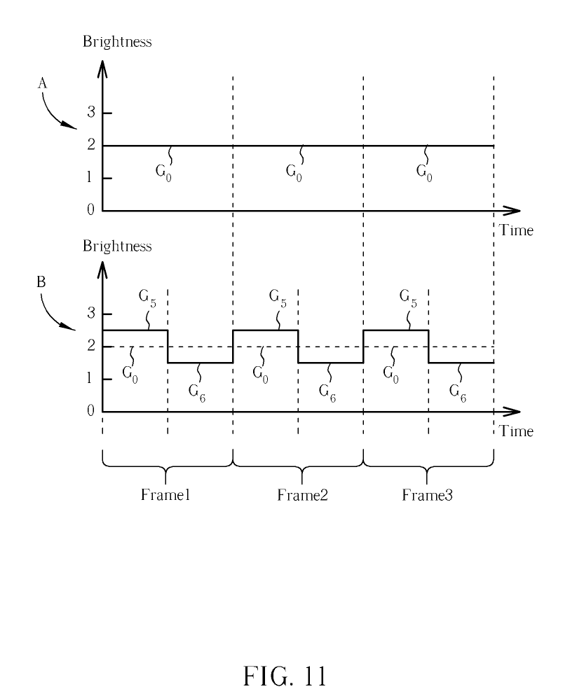

Please refer to FIG. 11. FIG. 11 is a diagram illustrating a fifth embodiment of the dark frame insertion method of the present invention. FIG. 11 is a diagram illustrating the brightness of the pixel of the LCD device utilizing the gamma curve in FIG. 9. FIG. 11A is same as FIG. 3A. The brightness of the pixel in FIG. 11B is generated by the dark frame insertion method of the present invention according to the gray level of the pixel in FIG. 11A and the gamma curve in FIG. 9: in the original frame 1 period, the gray level of the pixel is 20 and consequently the brightness of the pixel in the first half period according to the gamma curve G5 is 2.7 and the brightness of the pixel in the second half period according to the gamma curve G6 is 1.2; in the original frame 2 period, the gray level of the pixel is 20 and consequently the brightness of the pixel in the first half period according to the gamma curve G5 is 2.7 and the brightness of the pixel in the second half period according to the gamma curve G6 is 1.2; and in the original frame 3 period, the gray level of the pixel is 20 and consequently the brightness of the pixel in the first half period according to the gamma curve G5 is 2.7 and the brightness of the pixel in the second half period according to the gamma curve G6 is 1.2. Therefore, the dark frame insertion method of the present invention also can utilize two different gamma curves to eliminate ghost shadow effects while the brightness of the video frames after the dark frame inserted is still same as the brightness of the original video frames.

In actual implementation, by performing the dark frame insertion method of the present invention, the quantity of the frames processed by the LCD device is doubled, so the required ability to process higher frame rate may be exceeding the data processing ability of the video circuit of the LCD device. Thus, the dark frame insertion method of the present invention also may reduce the data quantity. For example, when the resolution of a video frame displayed on the LCD device is 1280×1024 pixels, the actual data quantity the LCD device received may be 1688×1066 pixels, which comprises extra vertical synchronization signals (V-sync) and horizontal synchronization signals (H-sync). The V-sync signals and the H-sync signals are located outside of displayed area of the LCD and are not seen by users. That is, the frame received by the LCD comprises the viewable frame data and the non-viewable system data. The present invention can also remove the non-viewable system data from each frame so as to prevent the total quantity of both the original video frames and the inserted dark frames exceeding the data processing limit of the video circuit of the LCD device.

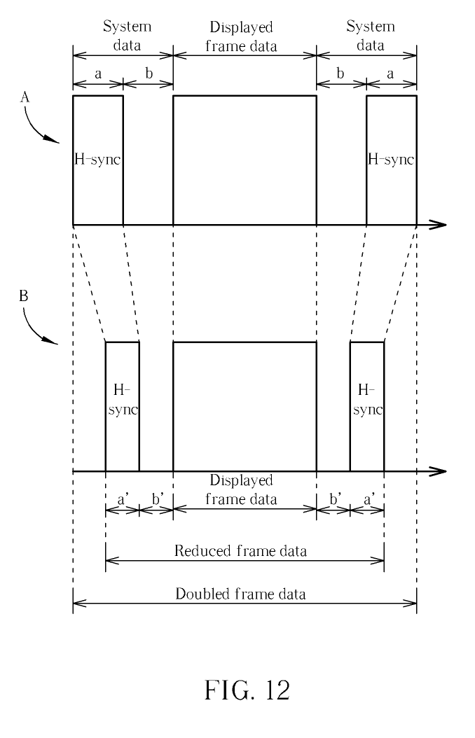

Please refer to FIG. 12. FIG. 12 is a diagram illustrating the method of the present invention for removing portion of the non-viewable frame data. FIG. 12A is a diagram illustrating the doubled frame data. FIG. 12B is a diagram illustrating the removed frame data. In FIG. 12, though the method of the present invention for removing the amount of the frame data is only illustrated in the horizontal direction, the method of the present invention for reducing the amount of the frame data is also applicable in the vertical direction. As shown in FIG. 12A, the doubled frame data comprises the displayed frame data and the system data. The method of the present invention removes the size of the original system data from (a+b+a+b) to (a′+b′+a′+b′). In this way, the frame data is effectively reduced.

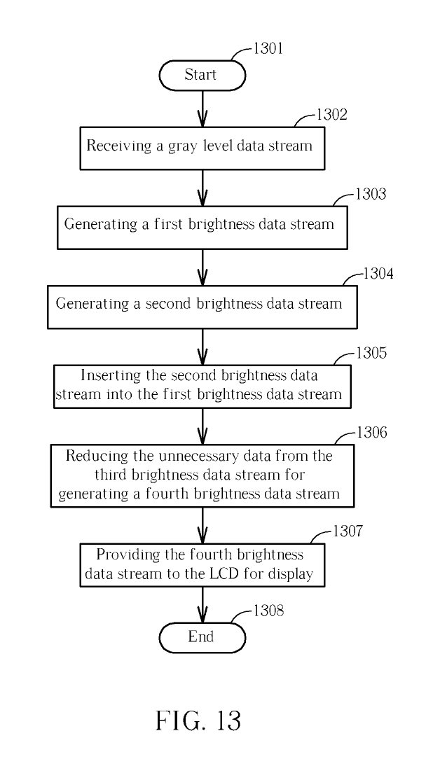

Please refer to FIG. 13. FIG. 13 is a flowchart illustrating the steps of the method of the dark frame insertion of the present invention. The steps are described as follows:

Step 1301: Start.

Step 1302: At a predetermined frequency, receive a gray level data stream.

Step 1303: Generate a first brightness data stream according to the gray level data stream and a first gamma curve.

Step 1304: Generate a second brightness data stream according to the gray level data stream and a second gamma curve.

Step 1305: Sequentially insert the second brightness data stream into the first brightness data stream for generating a third brightness data stream.

Step 1306: Remove the unnecessary data from the third brightness data stream for generating a fourth brightness data stream.

Step 1307: At the doubled predetermined frequency, provide the fourth brightness data stream to the LCD for display.

Step 1308: End.

In steps 1303 and 1304, the first and the second gamma curves make at least part of the received gray level data stream correspond to non-zero brightness, i.e., the brightness of the second half period will not be a complete black frame. Further, the first gamma curve can be different from the second gamma curve in order to generate the first brightness data stream which is brighter than the second brightness data stream. In step 1305, each brightness data of the second brightness data stream is inserted behind the corresponding brightness data of the first brightness data stream. In this way, in step 1307, each brightness data of the first brightness data stream is displayed earlier than the corresponding brightness data on the LCD.

To sum up, the method of dark frame insertion of the present invention eliminates the ghost shadow effect, decreases the degree of the image flicking, and improves the quality of the LCD.

Those skilled in the art will readily observe that numerous modifications and alterations of the device and method may be made while retaining the teachings of the invention.

What is claimed is:

1. A method for generating a frame stream to be displayed on a display device comprising:
(a) receiving a gray level data stream;
(b) generating a first brightness data stream according to the gray level data stream and a first gray level to brightness transformation;
(c) generating a second brightness data stream according to the gray level data stream and a second gray level to brightness transformation; and
(d) forming the frame stream by making the first brightness data stream interlaced with the second brightness data stream;
wherein the first gray level to brightness transformation and the second gray level to brightness transformation make at least part of the gray level data stream correspond to non-zero brightness.

2. The method of claim 1 wherein in step (a), the gray level data stream is received at a first frequency; and in step (d), the frame stream is formed at a second frequency doubled to the first frequency.

3. The method of claim 2 wherein the step (c), further comprising measuring brightness of the frame stream displayed on the display device with a color analyzer to adjust the second gray level to brightness transformation for making correlation between the gray level data stream and the frame stream in compliance with one selected from a group consisting of Gamma 1.8 and Gamma 2.2.

4. The method of claim 3 wherein the color analyzer uses the first frequency as a sampling frequency to sample brightness of the frame stream displayed on the display device for acquiring a synthesized brightness and adjusts the second gray level to brightness transformation according to the synthesized brightness and Gamma 1.8.

5. The method of claim 3 wherein the color analyzer uses the first frequency as a sampling frequency to sample brightness of the frame stream displayed on the display device for acquiring a synthesized brightness and adjusts the second gray level to brightness transformation according to the synthesized brightness and Gamma 2.2.

6. The method of claim 1 wherein the first gray level to brightness transformation and the second gray level to brightness transformation are different, so that the first brightness data stream is displayed on the display device earlier than the second brightness data stream, and the first brightness data stream is brighter than the second brightness data stream.

7. The method of claim 1 wherein the first gray level to brightness transformation and the second gray level to brightness transformation are same transformations when the first and the second gray level to brightness transformations transform gray levels below a predetermined gray level value; and the first gray level to brightness transformation and the second gray level to brightness transformation are different transformations when the first and the second gray level to brightness transformations transform gray levels above the predetermined value.

8. A method for generating a frame stream to be displayed on a display device comprising:
(a) receiving a gray level data stream;
(b) generating a first brightness data stream according to the gray level data stream and a first gray level to brightness transformation;
(c) generating a second brightness data stream according to the gray level data stream and a second gray level to brightness transformation;
(d) forming a interlaced stream by making the first brightness data stream interlaced with the second brightness data stream; and
(e) forming the frame stream by removing a system data from the interlaced stream;
wherein the first gray level to brightness transformation and the second gray level to brightness transformation make at least part of the gray level data stream correspond to non-zero brightness.

9. The method of claim 8 wherein in step (a), the gray level data stream is received at a first frequency; and in step (d), the frame stream is formed at a second frequency doubled to the first frequency.

10. The method of claim 9 further comprising measuring brightness of the frame stream displayed on the display device with a color analyzer to adjust the second gray level to brightness transformation for making correlation between the gray level data stream and the frame stream in compliance with one selected from a group consisting of Gamma 1.8 and Gamma 2.2.

11. The method of claim 10 wherein the color analyzer uses the frequency as a sampling frequency to sample brightness of the frame stream displayed on the display device for acquiring a synthesized brightness and adjusts the second gray level to brightness transformation according to the synthesized brightness and Gamma 1.8.

12. The method of claim 10 wherein the color analyzer uses the frequency as a sampling frequency to sample brightness of the frame stream displayed on the display device for acquiring a synthesized brightness and adjusts the second gray level to brightness transformation according to the synthesized brightness and Gamma 2.2.

13. The method of claim 8 wherein the first gray level to brightness transformation and the second gray level to brightness transformation are different, so that the first brightness data stream is displayed on the display device earlier than the second brightness data stream, and the first brightness data stream is brighter than the second brightness data stream.

14. The method of claim 8 wherein the first gray level to brightness transformation and the second gray level to brightness transformation are same transformations when the first and the second gray level to brightness transformations transform gray levels below a predetermined gray level value; and the first gray level to brightness transformation and the second gray level to brightness transformation are different transformations when the first and the second gray level to brightness transformations transform gray levels above the predetermined gray level value.

15. A display device with dark frame insertion, the display device comprising:
a receiving device for receiving a gray level data stream;
a first brightness generating device for generating a first brightness data stream according to the gray level data stream and a first gray level to brightness transformation;
a second brightness generating device for generating a second brightness data stream according to the gray level data stream and a second gray level to brightness transformation; and
a data interlacing device for interlacing the first brightness data stream with the second brightness data stream and providing the first brightness data stream interlaced with the second brightness data stream to the display device for displaying a frame stream;
wherein the first gray level to brightness transformation and the second gray level to brightness transformation make at least part of the gray level data stream correspond to non-zero brightness.

16. The display device of claim 15 wherein the receiving device at a frequency receives the gray level data stream and the data interlacing device at the doubled frequency provides the first brightness data stream interlaced with the second brightness data stream to the display device for displaying the frame stream.

17. The display device of claim 16 further comprising a color analyzer for measuring brightness of the frame stream to adjust the second gray level to brightness transformation for making correlation between the gray level data stream and the frame stream in compliance with one selected from a group consisting of Gamma 1.8 and Gamma 2.2.

18. The display device of claim 17 wherein the color analyzer uses the frequency as a sampling frequency to sample brightness of the frame stream for acquiring a synthesized brightness and adjusts the second gray level to brightness transformation according to the synthesized brightness and Gamma 1.8.

19. The display device of claim 17 wherein the color analyzer uses the frequency as a sampling frequency to sample brightness of the frame stream for acquiring a synthesized brightness and adjusts the second gray level to brightness transformation according to the synthesized brightness and Gamma 2.2.

20. The display device of claim 15 wherein the first gray level to brightness transformation and the second gray level to brightness transformation are different, so that the first brightness data stream is displayed on the display device earlier than the second brightness data stream, and the first brightness data stream is brighter than the second brightness data stream.

21. The display device of claim 19 wherein the first gray level to brightness transformation and the second gray level to brightness transformation are same transformations when the first and the second gray level to brightness transformations transform gray levels below a predetermined gray level value; and the first gray level to brightness transformation and the second gray level to brightness transformation are different transformations when the first and the second gray level to brightness transformations transform gray levels above the predetermined gray level value.
